(19) United States
(12) Patent Application Publication
(10) Pub. No.: US 2009/0328184 A1
(43) Pub. Date: Dec. 31, 2009

(54) System and Method for Enhanced Security of IP Transactions

(75) Inventors: Devarajan Puthupparambil, Rolling Meadows, IL (US); J Schneider, Grayslake, IL (US)

Correspondence Address: UTSTARCOM, INC., 3800 GOLF ROAD, SUITE 220, ROLLING MEADOWS, IL, 60008, US

(73) Assignee: UTStarcom, Inc., Alameda, CA (US)

(21) Appl. No.: 12/146,767

(22) Filed: Jun. 26, 2008

(51) Int. Cl. H04L 9/00; G06F 15/16

(52) U.S. Cl. 726/12

(57) ABSTRACT

A transaction routing system is described. The system includes a communication gateway linked to at least one transaction terminal and at least one host server. The communication gateway determines whether to perform an authentication procedure during a call session. Based on a result of the authentication procedure, at least one proceeding step is determined. A method for ensuring enhanced security during transaction routing is also provided.

### BACKGROUND

The invention generally relates to Internet Protocol based transaction sessions, and more specifically, to a system and method for enhanced security of Internet Protocol based transactions.

During an Internet Protocol (IP) based transaction, the originating devices and transaction instruments, such as the Point-of-Sale (POS) terminals, the web-servers, the credit cards, the debit cards, etc. are validated. This validation ensures that the originating parties involved are genuine parties. Generally, this validation is performed during the initialization process of the POS terminal or the web-server. However, after this initial validation, no further validation is performed.

With the increase in the number of IP-based transactions, validation of the transaction source once—during initialization—may not be enough. Moreover, any delay in the transaction processing makes the transaction process vulnerable to fraud by fraudulent entities. The increased traffic volume and any delay can therefore allow illegal POS terminals to perform valid credit card transactions. Similarly, fake web-servers may pose as valid servers and initiate transactions. In other words, possibility of unlawful and fraudulent entities misusing the source devices or imitating the source devices for unlawful practices is quite high. Such masquerading during IP-based transactions can cause huge financial losses both to the financial institutions and the users of the transaction instruments.

There is therefore a need for techniques to provide better security for the transactions conducted.

### SUMMARY

According to an aspect of the present techniques, a transaction routing system is provided. The system includes a communication gateway linked to at least one transaction terminal and at least one host server. The communication gateway determines whether to perform an authentication procedure during a call session. Based on a result of the authentication procedure, at least one proceeding step is determined. A method for ensuring enhanced security during transaction routing is also provided.

According to another aspect of the present techniques, a method for transaction routing is described. The method begins by establishing a call session between a transaction terminal and a host server through a communication gateway. Based on pre-determined settings, it is determined if an authentication procedure is required by the communication gateway. The authentication procedure is performed if required. At least one proceeding step is determined based on the pre-determined settings after performing the authentication procedure.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an exemplary IP-based transaction processing system for secure IP-based transactions, in accordance with aspects of the present techniques; and

FIG. 2 is a flow diagram representing the authentication process during a transaction in the IP-based transaction processing system of FIG. 1, in accordance with aspects of the present techniques.

### DETAILED DESCRIPTION OF EXEMPLARY EMBODIMENTS

In the following paragraphs, an Internet Protocol (IP) based transaction processing system for ensuring enhanced security during IP-based transactions, by establishing the identity of the source devices and entities, will be explained in detail. The approach described hereinafter provides techniques for authenticating source devices and entities during an ongoing call session, in order to enhance the security of the transaction session. The approach is described with reference to a network connection between an Internet Protocol Point-of-Service (IP POS) terminal and a host server. While the IP POS terminal may be defined as a transaction terminal facilitating different types of electronic transactions, it may include, in one embodiment, a Point-of-Sale terminal that is commonly used to retail credit or debit transactions. The transactions performed over the IP POS terminals and the Internet Protocol (IP) based network, which broadly includes a communication gateway and a host server, are processed in a secure manner using various IP protocols, transaction protocols, and, security or authentication and authorization protocols. As will be appreciated by those of ordinary skill in the art, the techniques are applicable to various systems that perform a secure transaction when conducted in conjunction with an IP-based network. Indeed, the exemplary uses and implementations described herein are merely provided as examples to facilitate understanding of the presently contemplated techniques. Therefore, the various aspects of the present technique will be explained, by way of examples only, with the aid of figures hereinafter.

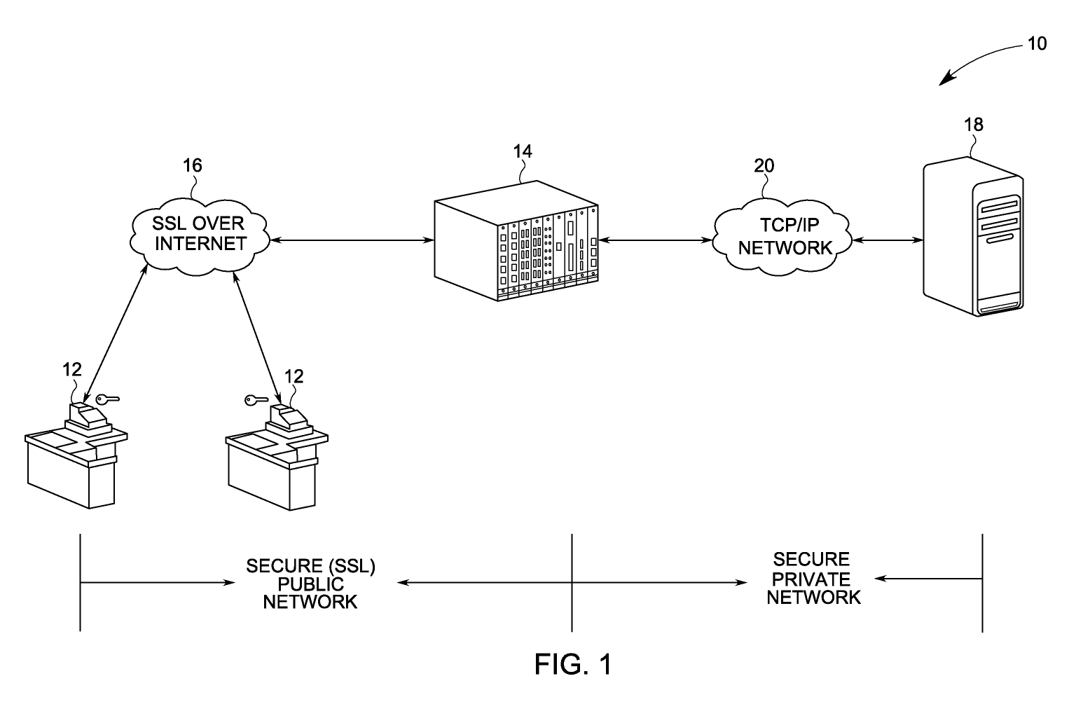

Referring generally to FIG. 1, the transaction process will be described by reference to an exemplary communication platform designated generally by numeral 10. It should be appreciated however, that the communication platform 10 may find application in a range of settings and systems, and that its use in conducting secure transactions described herein is but one such application. As will be explained in detail, the communication platform 10 is employed in various kinds of applications ranging from simple POS transactions to more complex communications, such as for example, a secure access, a secure message exchange between two devices, and the like.

The communication platform 10 includes many transaction terminals 12, such as IP POS transaction terminals, deployed at various establishments, like shops and retail locations. The technique however, is equally functional with the transaction terminals 12 replaced by web-servers, which can initiate the transaction session. Each of the IP POS transaction terminals 12 is capable of accepting or performing a financial transaction through a credit card, a debit card, or any such financial instrument as may be contemplated by one of ordinary skill in the art. Furthermore, the transaction terminal 12 is also capable of handling other transactions such as a secure access or a secure message exchange. Each transaction terminal 12 is linked with a transaction gateway or a communication gateway 14 through a secure public network, such as but not limited to a Secure Sockets Layer (SSL) network over the Internet 16 or an Internet Protocol Security (IPSec) connection. Various transaction protocols, which may include at least one host-compatible transaction protocol, may be used to link the terminals 12 and the communication gateway 14. The communication gateway 14 is preferably configured to convert an incoming communication that uses a certain transaction protocol into an aggregated outgoing communication that uses the host-compatible transaction protocol. Therefore, it serves to facilitate compatible communication exchanges between multiple end users (such as various IP POS transaction terminals 12) and, for example, an authorization host server.

Many such communication gateways 14 are further linked to a host server 18 over a secure private network, such as via a simple socket connection like Transmission Control Protocol (TCP) socket connection or a Transmission Control Protocol/Internet Protocol (TCP/IP) network 20, as illustrated. The host server 18 may similarly include a host socket connection, which links to the communication gateway 14 and facilitates provision of the outgoing communication that is aggregated. Those skilled in the art would recognize that a range of IP protocols or socket connections may be utilized, such as but not limited to Network Time Protocol (NTP), User Datagram Protocol (UDP), Domain Name System (DNS), Lightweight Directory Access Protocol (LDAP), Routing Information Protocol (RIP) and its IP versions of RIP, RIPv1, RIPv2, and RIPng, Open Shortest Path First (OSPF), as presently known, or others hereafter developed. The transaction protocols supported by the transaction gateway or the communication gateway 14 in order to conduct a transaction include VISAI (EIS 1051), VISAII (EIS 1052), ISO 8583, Transport Protocol Data Unit (TPDU), Transparent protocol, and, various custom protocols as are known in the art to facilitate interaction between host servers 18 and terminals 12.

In an exemplary transaction, a transaction session is initiated, during which, the source devices and entities are validated and authenticated. Once initiated, the call session is established, and the call session proceeds in the normal manner, primarily facilitating exchange of data. During the ongoing call session, the communication gateway 14 checks if an authentication procedure is to be performed, via an authentication requirement check. If the communication gateway 14 determines that there is no requirement for authentication, the call session proceeds in the normal manner and when the data exchange is complete, the call session is closed or terminated. The communication gateway 14 may determine if an authentication procedure is required for a particular call session based on various factors such as the kind of call session in progress, pre-configured settings of the clearing house, pre-configured settings of the merchant, pre-configured settings of the website administrator, dynamic external input from fraud handling servers, and the like. For example, if the transaction session is a highly secure one, such as a funds transfer or a credit authorization, the communication gateway 14 may decide to perform an authentication procedure. However, for a low-security data exchange, the communication gateway 14 may decide to skip the authentication procedure and proceed with the call session. Again, the communication gateway 14 may attempt to determine if an authentication procedure is required or not at various stages during the call session. If the communication gateway 14 determines that authentication is required, an authentication procedure is performed. If the authentication is successful, the communication gateway 14 again proceeds with the normal call session. However, if the authentication is unsuccessful, the communication gateway 14 may terminate the call session. The authentication procedure may involve usage of existing standards and/or custom procedures not limited to transmission and verification of predefined alphanumeric strings of specific lengths, encrypted keywords, and binary blobs. It may also involve usage of external servers or local devices for verification.

While the call session is proceeding, the communication gateway 14 may once again check if authentication is required or not. This authentication requirement check, may be initiated by an owner of the transaction routing system, such as the merchant, the website administrator, or the clearing house specifications on the fly, or may be randomly performed by the communication gateway 14, as defined or determined by the owner. If it is determined by the communication gateway 14 that there is no need for an authentication, the call session may proceed in the normal manner and be terminated. If authentication has to be performed, the communication gateway 14 re-authenticates the source devices and entities, and if the authentication is successful, the call session continues and after the data exchange is completed, the session is terminated by the communication gateway. However, the result of the authentication procedure may determine the proceeding step for the system, as described below. For example, if the result of the authentication procedure indicates an unsuccessful authentication, the communication gateway 14 may determine the proceeding step, that is, whether the call session is to be continued, revalidated, or terminated. Based on the proceeding step, the call session is continued normally, re-authenticated, or terminated.

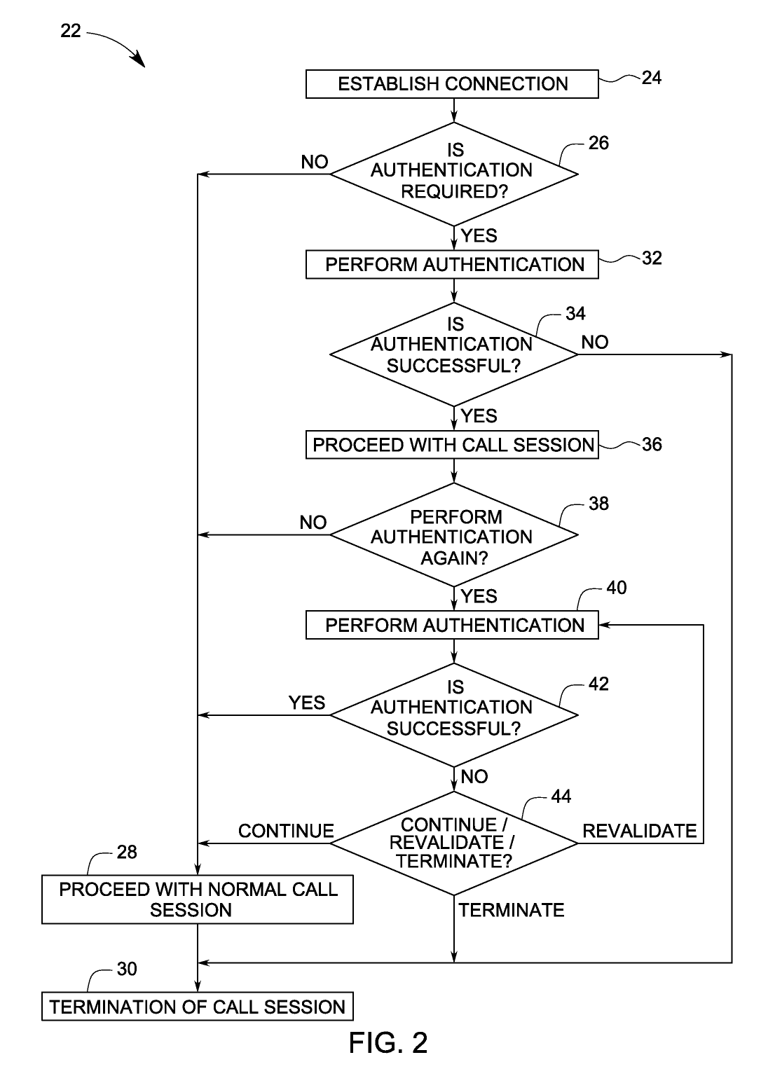

The procedure will become better understood when described with reference to FIG. 2 which illustrates a flow diagram of the authentication process 22 employed by the communication platform 10 to enhance the security of the system. Once a transaction or call session is initiated by the transaction terminal 12, the communication gateway 14 establishes connection 24 with the host server 18 as per the call session requirements. The call session proceeds normally with the exchange of data between the transaction terminal 12 and the host server 18. During the ongoing call session, the communication gateway 14 may check if authentication is required as shown in step 26. If no authentication is required, the call proceeds normally 28 and is consequently terminated 30 by the communication gateway once the exchange of data is complete. However, if authentication is required by the system, the communication gateway 14 performs the authentication 32. It may be noted that the communication gateway 14 may determine whether authentication is required or not via an authentication requirement check, based on various factors, such as the kind of transaction in progress, the specifications set by the clearing house, the specifications set by the merchant or the website administrator, among other criteria. Based on the result of the authentication procedure 32, the communication gateway 14 checks if the authentication is successful 34. If the authentication is not successful, the call session may be terminated 30 by the communication gateway 14. However, if the authentication is successful, the call session proceeds normally 36. Again, at a different point during the call session, the communication gateway 14 may optionally perform an authentication requirement check or check 38 if authentication is required by the system. If an authentication is required, the communication gateway 14 performs authentication, as shown in step 40, and, if there is no requirement of an authentication, the system continues with the normal exchange of data 28.

The result of the authentication procedure is checked 42 by the communication gateway 14 to determine the proceeding step, which may involve continuing with the call session, revalidating the call session, or terminating the call session. For example, if the authentication procedure is successful, the call session proceeds normally 28. If, however, the authentication procedure is unsuccessful, the communication gateway 14 determines if the call session should be aborted or continued in step 44. If it has to be aborted, the call session is terminated 30 by the communication gateway 14. However, if the communication gateway 14 determines that the call session should be proceeded with, the communication gateway checks, in step 42, if it should continue with the call session. If the communication gateway 14 determines at step 44 that the call session should be proceeded normally, the communication gateway proceeds with the call session 28, and completes the session 30. On the other hand, if the communication gateway 14 determines at step 44 that the source entities should be further validated before proceeding with the call session, the process follows step 40 by performing an authentication procedure again.

Various factors, as may be defined by pre-determined settings, are used by the communication gateway 14 to determine the following: whether to perform an authentication procedure, the number of times the system should perform authentication procedures, whether to continue the call session after an unsuccessful authentication procedure, whether to revalidate the source devices after an unsuccessful authentication procedure, etc. These pre-determined settings may be directly or indirectly based on the security level determined by the owner of the transaction processing system, like the merchant, the website administrators, the clearing house, or transaction service providers, among others. For example, certain transactions may be pre-defined (or pre-determined) as requiring higher security, such as for example, credit transactions of high amounts, funds transfer, etc. while others may be defined as requiring lower or medium security level. Based on these and other factors and criteria, the security level determining authority or the owner can change the settings or specifications accordingly. Thus, this authentication procedure ensures that the optimum level of security is maintained and enforced for any given transaction, and further determines the proceeding step based on the result of the authentication procedure. Furthermore, the techniques described hereinabove establishes the identity of the source devices or source entities by utilizing the authentication procedure. By establishing the identity of the source devices or source entities, the transaction routing system ensures that valid source devices or entities are attempting to execute the transaction.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A transaction routing system, comprising:
a communication gateway communicatively coupled to at least one transaction terminal and at least one host server, and configured to determine whether to perform an authentication procedure during a call session, and determine at least one proceeding step based on a result of the authentication procedure.

2. The transaction routing system of claim 1, wherein the communication gateway is configured to determine whether to perform the authentication procedure based on an authentication requirement check.

3. The transaction routing system of claim 2, wherein the authentication requirement check is executed by an owner of the transaction routing system.

4. The transaction routing system of claim 2, wherein the authentication requirement check is executed based on a pre-determined setting.

5. The transaction routing system of claim 1, wherein the communication gateway is configured to perform the authentication procedure on source devices.

6. The transaction routing system of claim 1, wherein the at least one proceeding step comprises continuing with the call session.

7. The transaction routing system of claim 1, wherein the at least one proceeding step comprises terminating the call session.

8. The transaction routing system of claim 1, wherein the at least one proceeding step comprises revalidating the call session.

9. The transaction routing system of claim 1, wherein the at least one proceeding step is pre-defined by an owner of the transaction routing system.

10. A method for transaction routing, the method comprising:
establishing a call session between at least one transaction terminal and at least one host server through a communication gateway;
determining if an authentication procedure is required by the communication gateway via an authentication requirement check; and
performing the authentication procedure based on the authentication requirement check and determining at least one proceeding step based on the authentication procedure.

11. The method of claim 10, comprising:
initiating the call session at the at least one transaction terminal.

12. The method of claim 10, wherein determining if the authentication procedure is required comprises determining if the authentication procedure is required based on pre-determined settings.

13. The method of claim 10, wherein performing the authentication procedure comprises performing the authentication procedure if the authentication procedure is required.

14. The method of claim 10, wherein performing the authentication procedure comprises proceeding with the call session if the authentication procedure is not required.

15. The method of claim 10, wherein determining the at least one proceeding step comprises continuing with the call session.

16. The method of claim 10, wherein determining the at least one proceeding step comprises terminating the call session.

17. The method of claim 10, wherein determining the at least one proceeding step comprises revalidating the call session via the authentication procedure.

18. The method of claim 10, wherein determining the at least one proceeding step comprises determining the at least one proceeding step based on pre-determined settings.

19. A method for transaction routing, the method comprising:
establishing a call session between a transaction terminal and a host server via a communication gateway;
determining if an authentication procedure is required by the communication gateway based on pre-determined settings; and
performing the authentication procedure if the authentication procedure is required and determining at least one proceeding step based on the pre-determined settings after performing the authentication procedure.

20. The method of claim 19, wherein determining the at least one proceeding step comprises at least one of continuing with the call session, terminating the call session, or revalidating the call session via the authentication procedure.
